(19) United States
(12) Patent Application Publication
(10) Pub. No.: US 2005/0273369 A1
(43) Pub. Date: Dec. 8, 2005

(54) Recall support system, recall support method, and programs therefor

(75) Inventors: Nobuyuki Ota, Yokohama (JP); Youichirou Tamura, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/093,623

(22) Filed: Mar. 29, 2005

(30) Foreign Application Priority Data
Mar. 29, 2004 (JP) 2004-095823
Sep. 22, 2004 (JP) 2004-275483

(51) Int. Cl. G06F 17/60

(52) U.S. Cl. 705/4

(57) ABSTRACT

A recall support system to present a plurality of recall countermeasures different in conditions and also costs and numbers of days required for implementing the countermeasures. The system comprises a product attribute acquiring section that acquires complaint information associated with the occurrence of a problem in a product from an input interface and extracts an attribute of a product included in the complaint information; a countermeasure information acquiring section that acquires information about a cost or time period required for a countermeasure or cause investigation by referring the attribute of the product to a basic database, the cost or time period being corresponding to the attribute of the product of concern; an evaluation index calculation section that extracts information about an execution scope of each type of countermeasure or cause investigation included in a countermeasure database, and by applying the acquired information about the cost or time period required for the countermeasure or cause investigation to the execution scope, calculates evaluation indices including a cost or time period for each type of countermeasure or cause investigation; and an output processing section that outputs information about the evaluation indices to an output interface.

### CROSS-REFERENCE TO RELATED APPLICATIONS

The present application claims priority upon Japanese Patent Application No. 2004-095823 filed on Mar. 29, 2004, and Japanese Patent Application No. 2004-275483 filed on Sep. 22, 2004, which are herein incorporated by reference.

### BACKGROUND OF THE INVENTION

1. Field of the Invention

The present invention relates to a recall support system, a recall support method, and recall support programs, and particularly to a recall support system which notifies involved companies of a countermeasure such as suspension of the sale or recall for a product that has the occurrence of a problem and thus complaints from users or the like, and requests the involved companies to investigate the cause of the problem.

2. Description of the Related Art

An intention decision display method disclosed in Japanese Patent Application Laid-open Publication No. 11-316781 or the like has been proposed as a method to offer a guideline for actions to be taken when a problem in a product or a disaster occurs, which, a plurality of terminals and a host computer being involved, stores beforehand operations and action plans for a business entity to implement when a disaster occurs in a storage apparatus of the host computer or a terminal, and in response to the input of the damage situation caused by a disaster, automatically assigns priorities to the operations and action plans and displays the operations and action plans listed in order of priority on the screen of a terminal, and also creates and displays new operations and action plans according to the damage situation.

In the conventional art, although a plurality of countermeasures such as suspension of the sale and recall of the product conceivable as a guideline for actions at recall should be proposed to the decision maker to support the decision making, a plurality of countermeasures have not been proposed.

Furthermore, there is the problem that, although the suspension of the sale and recall conceivable as countermeasures differ in cost and number of days required for the countermeasure depending on the scope of products to be subject thereto (limited by, for example, where and when the products are manufactured), estimates are not presented to the decision maker, and hence information to make a decision based on is scarce.

### SUMMARY OF THE INVENTION

Accordingly, an object of the present invention is to enable presenting a plurality of recall countermeasures different in conditions and also costs and numbers of days required for implementing the countermeasures.

A recall support system of the present invention to solve the above task is a system to present countermeasures or cause investigation for when problems occur in products, the system comprising a function that can use a basic database storing information about costs or time periods required for the countermeasures or cause investigation, the costs or time periods being corresponding to attributes of products, and a countermeasure database storing information about an execution scope of each type of countermeasure or cause investigation of the countermeasures or cause investigation; a product attribute acquiring section that acquires complaint information associated with the occurrence of a problem in a product from an input interface and extracts the attribute of the product included in the complaint information; a countermeasure information acquiring section that acquires information about a cost or time period required for a countermeasure or cause investigation by referring the attribute of the product to the basic database, the cost or time period being corresponding to the attribute of the product of concern; an evaluation index calculation section that extracts the information about the execution scope of each type of countermeasure or cause investigation included in the countermeasure database, and by applying the acquired information about the cost or time period required for the countermeasure or cause investigation to the execution scope, calculates evaluation indices including a cost or time period for each type of countermeasure or cause investigation; and an output processing section that outputs information about the evaluation indices to an output interface.

A recall support method of the present invention is a method to present countermeasures or cause investigation for when problems occur in products by an information processing apparatus, the method comprising the steps of enabling use of a basic database storing information about costs or time periods required for the countermeasures or cause investigation, the costs or time periods being corresponding to attributes of products, and a countermeasure database storing information about an execution scope of each type of countermeasure or cause investigation of the countermeasures or cause investigation; acquiring complaint information associated with the occurrence of a problem in a product from an input interface and extracting the attribute of the product included in the complaint information; acquiring information about a cost or time period required for a countermeasure or cause investigation by referring the attribute of the product to the basic database, the cost or time period being corresponding to the attribute of the product of concern; extracting the information about the execution scope of each type of countermeasure or cause investigation included in the countermeasure database, and by applying the acquired information about the cost or time period required for the countermeasure or cause investigation to the execution scope, calculating evaluation indices including a cost or time period for each type of countermeasure or cause investigation; and outputting information about the evaluation indices to an output interface.

A recall support program of the present invention is a program to present countermeasures or cause investigation for when problems occur in products by an information processing apparatus which can use a basic database storing information about costs or time periods required for the countermeasures or cause investigation, the costs or time periods being corresponding to attributes of products, and a countermeasure database storing information about an execution scope of each type of countermeasure or cause investigation of the countermeasures or cause investigation, the program comprising the steps of acquiring complaint information associated with the occurrence of a problem in a product from an input interface and extracting the attribute of the product included in the complaint information; acquiring information about a cost or time period required for a countermeasure or cause investigation by referring the attribute of the product to the basic database, the cost or time period being corresponding to the attribute of the product of concern; extracting the information about the execution scope of each type of countermeasure or cause investigation included in the countermeasure database, and by applying the acquired information about the cost or time period required for the countermeasure or cause investigation to the execution scope, calculating evaluation indices including a cost or time period for each type of countermeasure or cause investigation; and outputting information about the evaluation indices to an output interface.

The present invention enables presenting a plurality of recall countermeasures different in conditions and also costs and numbers of days required for implementing the countermeasures.

Features and objects of the present invention other than the above will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a view of the configuration of a whole between-companies traceability system according to an embodiment of the present invention;

FIG. 2 is a view of the configuration of a recall support system and enterprise resource planning system of a maker;

FIG. 3 is a view showing a specific example of a countermeasure database;

FIG. 4 is a view showing a specific example of an evaluation basic database;

FIG. 5 is a view showing a specific example of a cause investigation basic value database;

FIG. 6 is a view showing a specific example of a manufacture history database;

FIG. 7 is a view showing a specific example of a bill-of-materials database;

FIG. 8 is a view showing a specific example of an inventory information database;

FIG. 9 is a view showing a specific example of a traceability database;

FIG. 10 shows the process flow from receipt of complaint information to implementing a countermeasure to requesting to investigate the cause;

FIG. 11 is a view showing the appearance of a complaint information input screen;

FIG. 12 is a view showing the appearance of a countermeasure display screen;

FIG. 13 is a view showing the appearance of a to-be-requested-for-cause-investigation company display screen;

FIG. 14 shows the process flow of calculating costs and number of days required for all countermeasures;

FIG. 15 shows the process flow of calculating costs and number of days required for the countermeasures for products having given production lot numbers;

FIG. 16 shows the process flow of calculating costs and numbers of days required for cause investigation;

FIG. 17 is a view showing the appearance of a countermeasure scope narrowing screen;

FIG. 18 is a view of the configuration of a whole between-companies traceability system according to a second embodiment of the present invention;

FIG. 19 is a view of the configuration of a maker side recall support system and a center side recall support system;

FIG. 20 is a view showing a specific example of an access control database;

FIG. 21 shows the process flow of calculating costs and number of days required for all countermeasures according to the second embodiment of the present invention;

FIG. 22 shows the process flow of calculating costs and numbers of days required for cause investigation according to the second embodiment of the present invention;

FIG. 23 is a view showing the appearance of a to-be-requested-for-cause-investigation company display screen according to the second embodiment of the present invention; and

FIG. 24 is a view showing the appearance of a whereabouts confirmation screen.

### DETAILED DESCRIPTION OF THE INVENTION

At least the following matters will be made clear by the explanation in the present specification and the description of the accompanying drawings.

The best mode for carrying out the invention will be described with reference to the drawings. In the present embodiment, a situation is considered where a maker manufactures products from a raw material delivered from a supplier and, for a problem that occurs in the products, plans and carries out a recall countermeasure using a recall support system of the present invention. Moreover, information about product whereabouts is collected for traceability from a series of distribution processes from the manufacture of the products to the delivery thereof from wholesalers to retailers, to the sale of the products to consumers through the retailers. However, the present invention is not limited to this, but can be applied to any situation where a recall is dealt with for products.

Embodiment 1

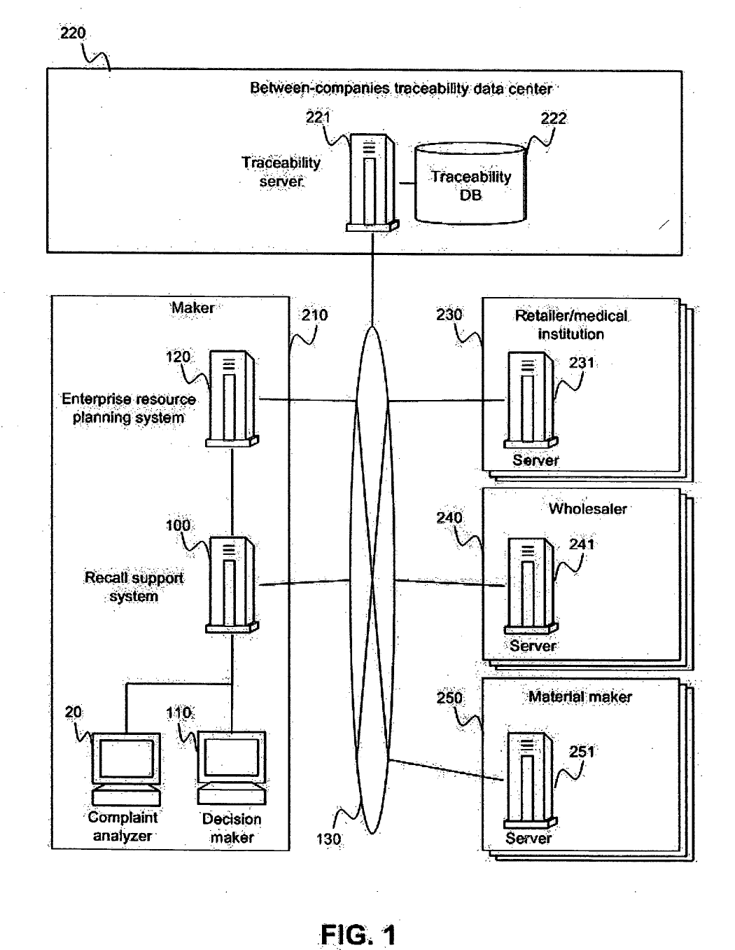

FIG. 1 is a view of the configuration of a whole between-companies traceability system including a recall support system 100 in use according to the best mode for carrying out the invention.

A complaint analyzer of a maker 210 manufacturing products enters complaint information from a consumer into a recall support system 100 via a terminal 20. The recall support system 100 acquires and uses data necessary for dealing with a recall from a traceability database 222 via a traceability server 221 of a between-companies traceability data center 220.

Then, the recall support system 100 identifies conceivable recall countermeasures and calculates the cost and number of days required for implementing each countermeasure, and furthermore, presents the conceivable countermeasures, candidates for being requested for cause investigation, and the like to a terminal 110 of a decision maker, and once a decision is made, instructs to execute the decision.

Note that the traceability server 221 of between-companies traceability data center 220 is for managing traceability between a plurality of parties involved in the products (between companies), not only maker 210 but also a retailer/medical institution 230, a wholesaler 240, a material maker 250, and the like, through traceability database 222.

Maker 210 registers data necessary for traceability of the products such as arrival and shipment thereof and processing state in traceability database 222 using an enterprise resource planning system 120. Retailer/medical institution 230, wholesaler 240, and material maker 250 register data necessary for the traceability in traceability database 222 using their own servers 231, 241, and 251. A communication line 130 is used in communication between these systems.

Note that various networks can be used as communication line 130, such as a dedicated line, a WAN (Wide Area Network), an electric wire network, a radio network, a public line network, and a cellular phone network as well as the Internet and a LAN. Alternatively, by using a virtual dedicated network technology such as a VPN on the Internet, communication of higher security is set up desirably.

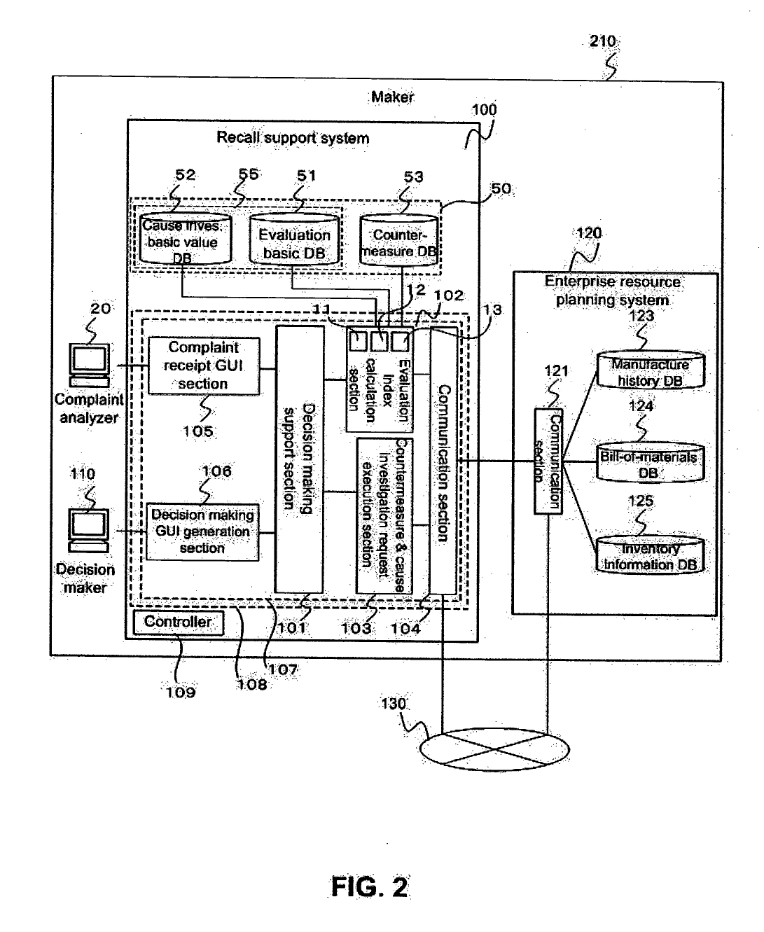

FIG. 2 illustrates in more detail the recall support system 100 and enterprise resource planning system 120 of maker 210. In FIG. 2, recall support system 100 comprises a decision making support section 101, an evaluation index calculation section 102, a countermeasure and cause investigation request execution section 103, a communication section 104, a complaint receipt GUI section 105, and a decision making GUI generation section 106. Note that these function sections of the recall support system of the invention may be realized by a program 107, which is stored in a storage apparatus (e.g. memory) 108 of the system and read out and executed by a controller 109 including a computing apparatus, i.e., a CPU.

Here, decision making support section 101 controls the process flow of the whole recall support system. Evaluation index calculation section 102 estimates evaluation indices necessary for decision making by the decision maker such as the cost and number of days required for implementing each countermeasure referring to an evaluation basic database 51, a cause investigation basic value database 52, a countermeasure database 53, and the like. The evaluation basic database 51 and cause investigation basic value database 52 are included in a basic database 55.

Moreover, evaluation index calculation section 102 comprises a product attribute acquiring section 11 that acquires complaint information due to the occurrence of a problem in a product from the complaint receipt GUI section 105 (input interface) and extracts a product attribute from the complaint information. Evaluation index calculation section 102 further comprises a countermeasure information acquiring section 12 that acquires information about the cost and time period required for implementing a countermeasure or cause investigation from basic database 55 which information is corresponding to the extracted product attribute, and further comprises a location information acquiring section 13 that acquires information about whereabouts of the products from traceability database 222 which information is corresponding to the extracted product attribute.

As described above, the evaluation index calculation section 102 extracts execution scope information for each type of countermeasure or cause investigation included in countermeasure database 53, and calculates the evaluation indices for each type of countermeasure or cause investigation by applying the information acquired from basic database 55 about the cost and time period required for implementing the countermeasure or the cause investigation to the execution scope information.

Moreover, the evaluation index calculation section 102 extracts candidates for being requested to implement the countermeasure or the cause investigation from one of basic database 55, countermeasure database 53, and traceability database 222, or from a database storing a list of parties to implement a countermeasure or cause investigation, and sends information about the candidates to the decision making GUI generation section 106 (output processing section) to have it output to an output interface.

The countermeasure and cause investigation request execution section (instruction execution section) 103 accepts the selection of a countermeasure or cause investigation through an input interface (that is a GUI displayed on the terminal 110 being used by the decision maker) in response to the evaluation index information output to the output interface (that is a GUI displayed on the terminal 110 being used by the decision maker) via decision making GUI generation section 106, and outputs an instruction to implement the countermeasure or cause investigation to an output interface. The output is output to the server 231 of the retailer/medical institution, the server 241 of the wholesaler, or the server 251 of the material maker, for example.

The communication section 104 communicates with enterprise resource planning system 120 and with the servers 231, 241, 251 of the other companies via communication line 130. The complaint receipt GUI section 105 is an interface that receives complaint information from terminal 20 of the complaint analyzer, and the decision making GUI generation section 106 generates an interface that presents the cost and time period required for implementing each countermeasure or cause investigation to terminal 110 of the decision maker and allows the decision maker to select a company to be requested to implement cause investigation and a countermeasure.

The enterprise resource planning system 120 is a system that manages and effectively utilizes all enterprise resources of maker 210 to support the efficient execution of operations. The enterprise resource planning system 120 comprises a communication section 121, a manufacture history database 123, a bill-of-materials database 124, and an inventory information database 125, and manages usual operations of maker 210 overall. The manufacture history database 123 is a database containing the manufacture history data of products manufactured in a factory, and the bill-of-materials database 124 is a database containing the arrangement of components of products and data about the components. The inventory information database 125 is a database containing inventory data of the products in a warehouse. The communication section 121 communicates with recall support system 100 and with the other companies via communication line 130.

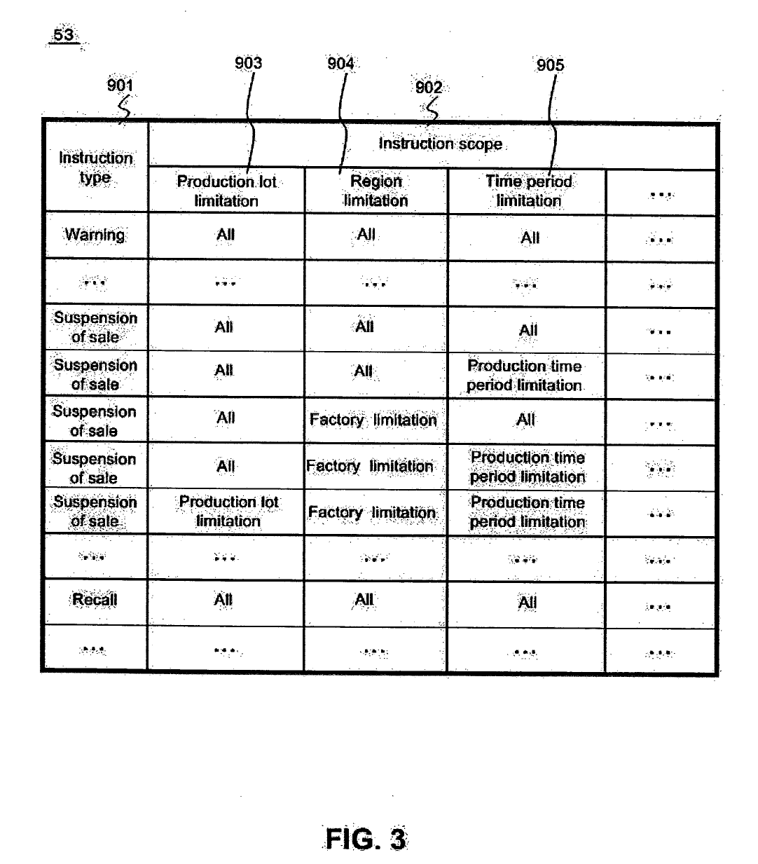

Next, each of the databases mentioned above will be described in detail. FIG. 3 shows an example of countermeasure database 53. Countermeasure database 53 is a database that stores, for each type of countermeasure or cause investigation, execution scope information of the countermeasure or cause investigation. Its data structure consists of, for example, an instruction type 901 and an instruction scope 902. Instruction type 901 indicates the content of an instruction to handle a recall to other companies such as a warning, the suspension of sale, or a recall. Instruction scope 902 specifies the scopes of products to be subject to the instruction content and comprises a production lot limitation 903, a region limitation 904, and a time period limitation 905.

Here, information of the production lot limitation 903 is for limiting the application scope of a recall countermeasure or the like on a production lot basis, and includes “all” that specifies all production lots and “production lot limitation” that specifies only the same lot as the complained-of product is from.

Information of the region limitation 904 is for limiting the application scope of a recall countermeasure or the like on a production region basis, and includes “all” that specifies all regions and “factory limitation” that specifies production lots produced in the same factory as the complained-of product is.

Information of the time period limitation 905 is for limiting the application scope of a recall countermeasure or the like on a production time period basis, and includes “all” that specifies all time periods and “time period limitation” that specifies production lots produced in the same time period as the complained-of product is.

Countermeasures are combinations of instruction type 901, production lot limitation 903, region limitation 904, and time period limitation 905, and the number of the countermeasures is the same as the number of the combinations.

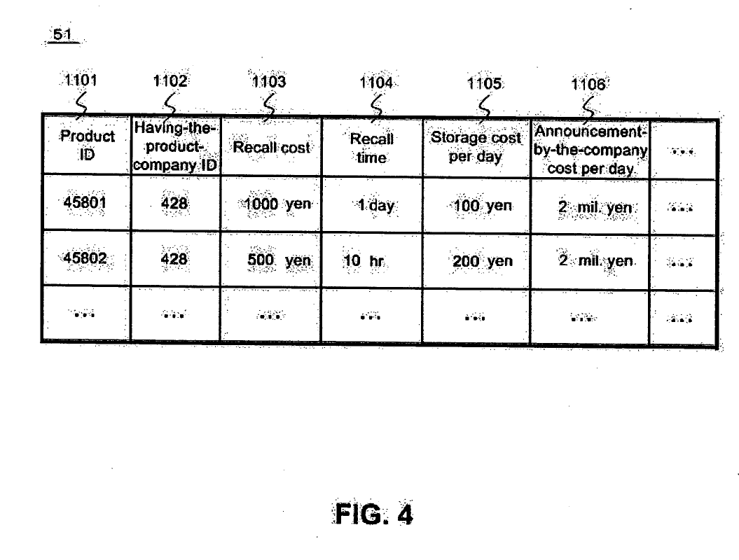

Next, evaluation basic database 51 and cause investigation basic value database 52 forming basic database 55 of the present invention will be described. FIG. 4 shows an example of evaluation basic database 51. The evaluation basic database 51 is a database containing data that is a base to calculate evaluation indices of countermeasures based on. The data structure has a product ID 1101 as a key and information such as a having-the-product-company ID 1102, a recall cost 1103, a recall time 1104, a storage cost per day 1105 and an announcement-by-the-company cost per day 1106 associated therewith.

Here, information of the product ID 1101 is a key data indicating with which product the data is associated, and information of the having-the-product-company ID 1102 indicates the identification number of a company having the product. Information of the recall cost 1103 indicates the cost for recalling one product from the company indicated in the having-the-product-company ID 1102, and information of the recall time 1104 indicates time required for product recall. Information of the storage cost per day 1105 indicates the cost for keeping one product for a day in the company indicated in the having-the-product-company ID 1102 because of the suspension of sale of the product, and information of the announcement-by-the-company cost per day 1106 indicates the cost required for announcing a warning about the product for a day.

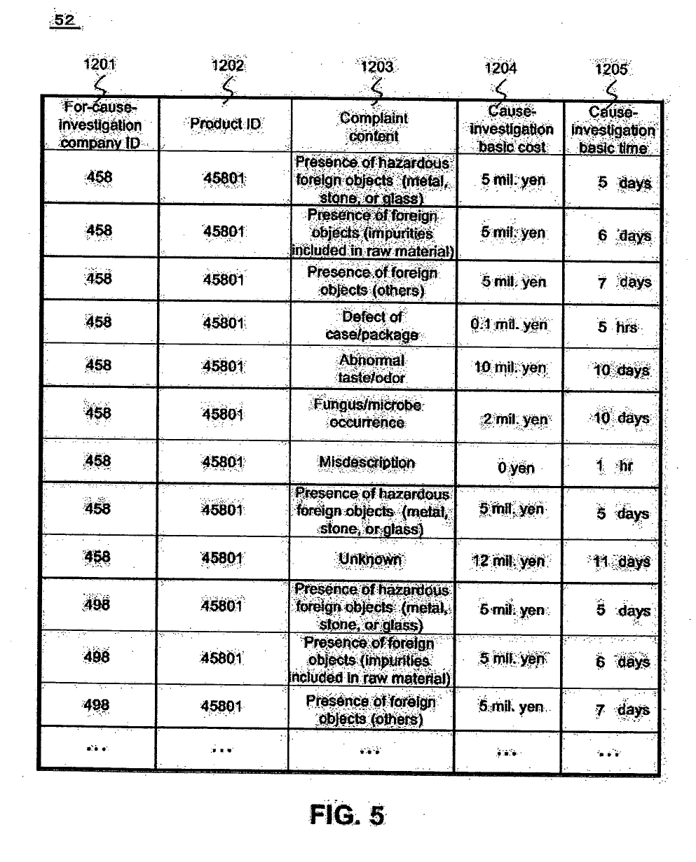

Next, cause investigation basic value database 52 will be described. FIG. 5 shows an example of cause investigation basic value database 52. Cause investigation basic value database 52 is a database that contains costs and numbers of days required for investigating the cause of recall occurrence. Its data structure has, for example, a for-cause-investigation company ID 1201 as a key and information such as a product ID 1202, a complaint content 1203, a cause-investigation basic cost 1204, and a cause-investigation basic time 1205 associated therewith.

Here, information of the for-cause-investigation company ID 1201 indicates a company conceivable as being requested to investigate the cause, and information of the product ID 1202 indicates a product conceivable as being subject to cause-investigation. Information of the complaint content 1203 indicates as a conceivable complaint content the presence of hazardous foreign objects (metal, stone, or glass) or foreign objects (impurities included in raw material) or the like. Information of the cause-investigation basic cost 1204 indicates the cost for requesting the company indicated in the for-cause-investigation company ID 1201 to investigate the cause of the complaint in the complaint content 1203 about the product in the product ID 1202, and information of the cause-investigation basic time 1205 indicates time required for cause investigation.

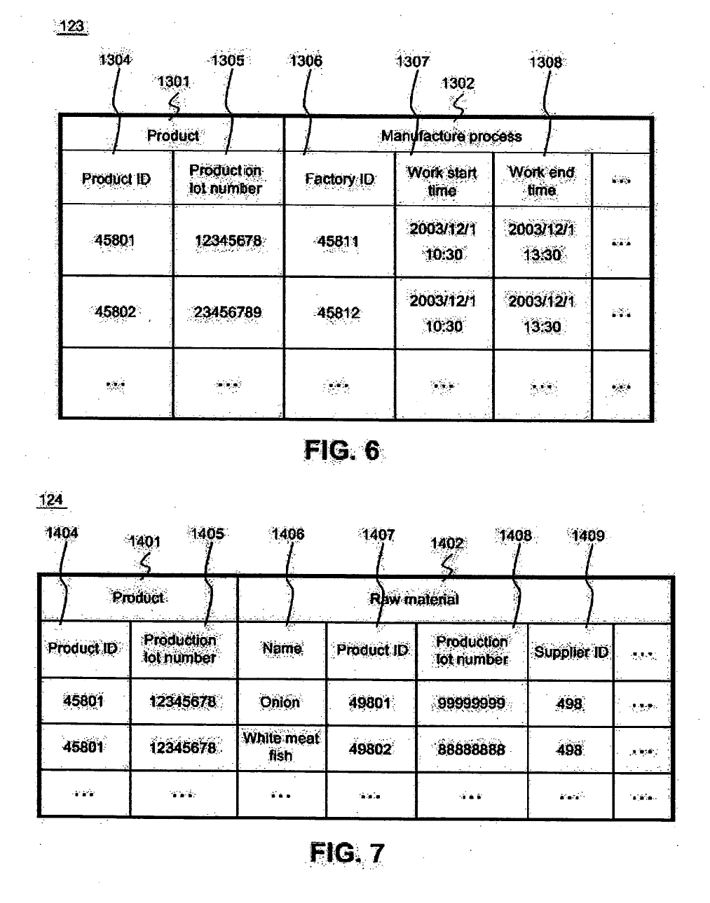

Next, the databases of enterprise resource planning system 120 will be described. FIG. 6 shows an example of manufacture history database 123. Manufacture history database 123 comprises information of both a product 1301 and a manufacture process 1302. Information of the product 1301 indicates with which product the data is associated and comprises a product ID 1304 denoting the identification number of a product and a production lot number 1305 denoting a production lot number of the product.

Information of the manufacture process 1302 comprises information of a factory ID 1306, a work start time 1307, a work end time 1308, and the like. Here, information of the factory ID 1306 indicates in which factory the product has been produced using the identification number of the factory, and information of the work start time 1307 indicates when the production of the product started, and information of the work start time 1307 indicates when the production of the product finished.

Next, bill-of-materials database 124 will be described. FIG. 7 shows an example of bill-of-materials database 124. Bill-of-materials database 124 comprises information of both a product 1401 and a raw material 1402. Information of the product 1401 indicates with which product the data is associated and comprises a product ID 1404 denoting the identification number of a product and a production lot number 1405 denoting a production lot number of the product. And information of the raw material 1402 comprises a name 1406, a product ID 1407, a production lot number 1408, a supplier ID 1409, and the like. Here, the name 1406 indicates the name of a raw material, the product ID 1407 indicates the identification number of the raw material as a product, the production lot number 1408 indicates a production lot number of the raw material, and the supplier ID 1409 indicates the identification number of the company that has supplied the raw material.

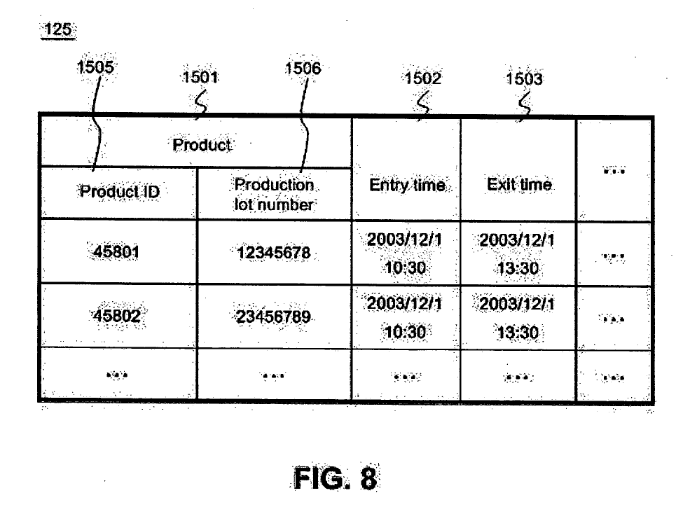

Next, inventory information database 125 will be described. FIG. 8 shows an example of inventory information database 125. Inventory information database 125 comprises information of a product 1501, an entry time 1502, an exit time 1503, and the like. Information of the product 1501 indicates with which product the data is associated and comprises a product ID 1505 denoting the identification number of a product and a production lot number 1506 denoting a production lot number of the product. And information of the entry time 1502 indicates time when the products entered a warehouse and information of the exit time 1503 indicates time when the products exited the warehouse.

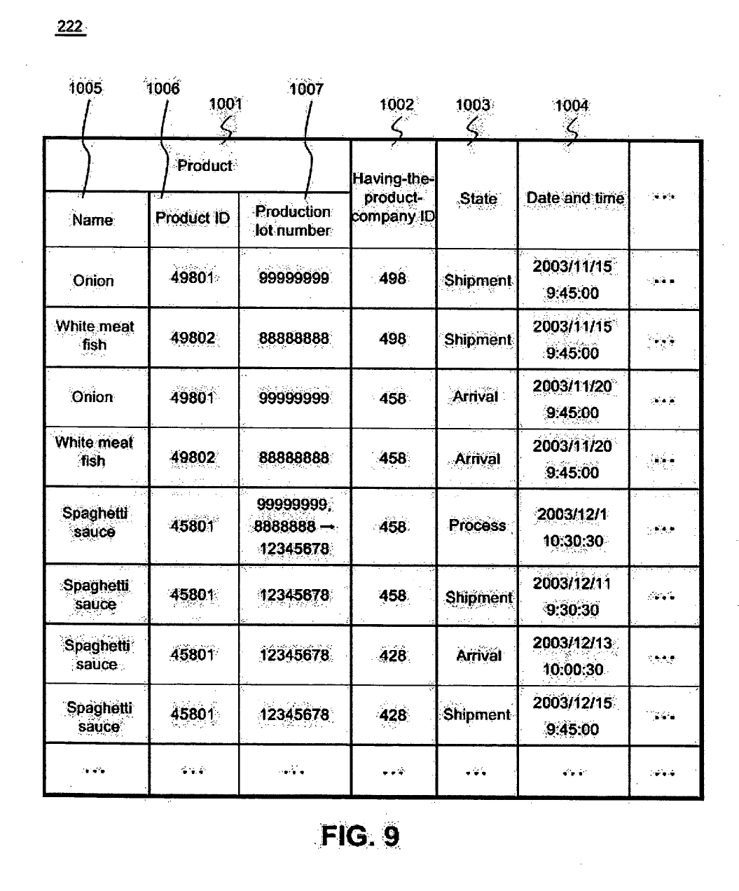

Next, traceability database 222 will be described. FIG. 9 shows an example of traceability database 222. Traceability database 222 is a database that contains data registered by maker 210, retailer/medical institution 230, wholesaler 240, and material maker 250, which data comprises information of a product 1001, a having-the-product-company ID 1002, a state 1003, a date and time 1004, and the like.

Here, information of product 1001 comprises information of a name 1005 indicating a product name, a product ID 1006 indicating the identification number of the product's type such as EAN (European Article Number) and a production lot number 1007 indicating a production lot number of the product, and indicates with which product the data is associated. Information of having-the-product-company ID 1002 indicates the identification number of a company that registered the data, information of state 1003 indicates the state of the products (shipment, process, arrival, etc.), and information of date and time 1004 indicates the date and time for state 1003.

Note that each section 101 to 106 of recall support system 100 may be embodied as hardware or as a program stored in an appropriate storage apparatus such as an HDD or memory, which program the controller 109 of the system reads out from the storage apparatus into memory 108 as needed and executes it.

As opposed to the embodiment where recall support system 100 is connected to the external apparatuses of terminal 20 of the complaint analyzer, terminal 110 of the decision maker, enterprise resource planning system 120, and between-companies traceability data center 220 via communication line 130, and sends/receives data therewith, an embodiment where all or some of the above external apparatuses are included, as components of recall support system 100, in recall support system 100 is conceivable. Furthermore, in the case of recall support system 100 comprising the external apparatuses, they may cooperate with it over communication line 130 or be integrated in hardware with it.

Although recall support system 100 is managed by the maker side in the present embodiment, it may be disposed as, for example, an ASP server on a network so as to be used by a plurality of companies as needed. Such an embodiment will be described later in Embodiment 2.

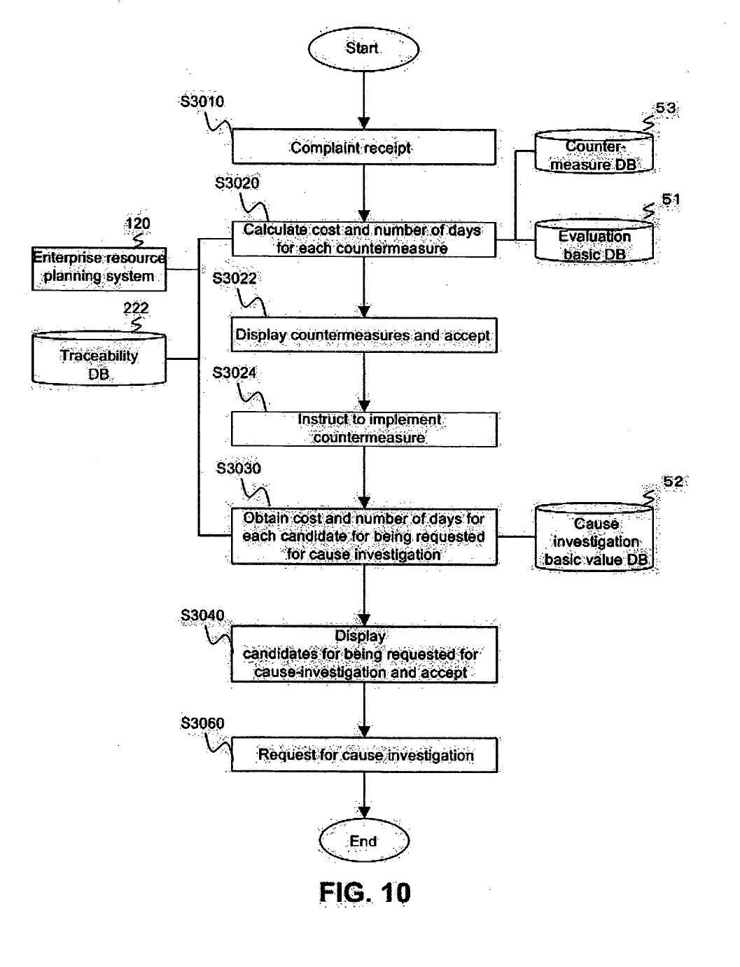

Next, the execution procedure of a recall support method according to the present embodiment will be described. FIG. 10 shows the process flow in recall support system 100 from receipt of complaint information through the complaint analyzer to implementing a countermeasure to requesting to investigate the cause when a consumer complains of a product. Note that this process flow is controlled by the decision making support section 101.

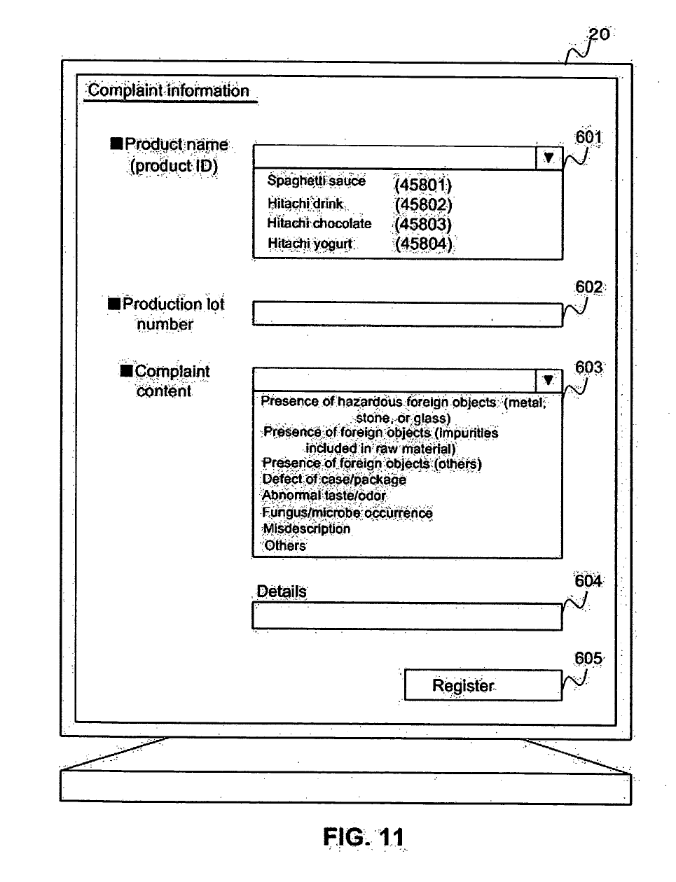

In process S3010, complaint receipt GUI section 105 of recall support system 100 sends data of a complaint information input screen to terminal 20 of the complaint analyzer to display. A configuration example of this complaint information input screen is shown in FIG. 11. The complaint information input screen has a product name (product ID) 601, a production lot number 602, a complaint content 603, a detail 604, and a register button 605.

The product name 601 is a list of products dealt in by makers and the complaint analyzer selects a complained-of product from the list. This selection from product name 601 is indispensable. Note that the product list may be a list of products having the exit time 1503 fixed, i.e. already shipped, out of the products 1501 of inventory information database 125.

The production lot number 602 is the production lot number of the complained-of product, and the complaint analyzer hears the number from the consumer and enters. The input of the production lot number 602 is dispensable. The complaint content 603 is a list of complaint contents and the complaint analyzer selects one closest to the actual complaint from the list. This selection from complaint content 603 is dispensable. The list of complaint contents is a list of the complaint contents 1203 of cause investigation basic value database 52. Note that after the complaint analyzer selects a specific product from product name 601, only complaint contents 1203 associated with product IDs 1202 corresponding to the specific product may be displayed. The detail 604 is for entering the details of the complaint content 603 and the complaint analyzer enters. The detail 604 is dispensable.

The complaint receipt GUI section 105 provides this screen for the terminal 20, and through the screen, accepts complaint information entered by the complaint analyzer operating the terminal 20 in response to the press of the register button 605.

Subsequently, in process S3020, evaluation index calculation section 102 calculates a cost required for a warning, a cost required for the suspension of sale, and a cost and number of days for a recall using traceability database 222, enterprise resource planning system 120, countermeasure database 53, and evaluation basic database 51.

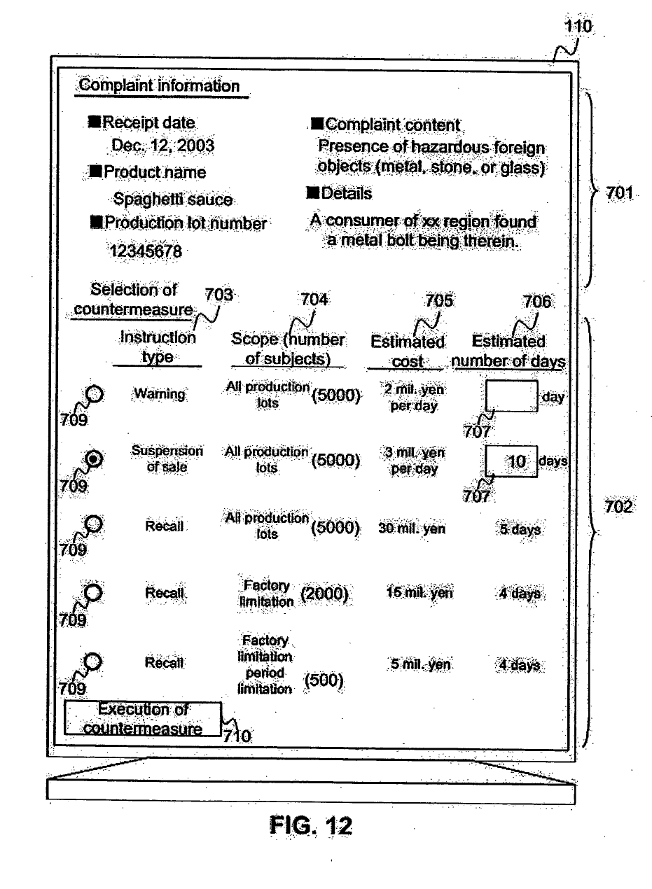

In process S3022, decision making GUI generation section 106 puts together the cost and number of days calculated in process S3020 for each countermeasure and displays on terminal 110 of the decision maker, and searches inventory information database 125 of enterprise resource planning system 120 for ones whose exit time 1503 is fixed out of production lot numbers that are subject to the countermeasure, to display the number of the ones. Here, an example of the countermeasure display screen displayed is shown in FIG. 12. The countermeasure display screen of FIG. 12 has a complaint information 701 and the selection of a countermeasure 702. The complaint information 701 displays complaint information such as a product name entered by the complaint analyzer through 20, a production lot number, a complaint content, the details of the complaint content, and its input receipt date. The selection of a countermeasure 702 presents countermeasures, and comprises an instruction type 703, a scope (number of subjects) 704, an estimated cost 705, an estimated number of days 706, a checkbox 709, and a countermeasure execution button 710.

The instruction type 703 displays an instruction type 901 of countermeasure database 53. The scope (number of subjects) 704 presents a display according to the instruction scope 902. For example, if production lot limitation 903, region limitation 904, and time period limitation 905 are all set to be “all”, “all products” is displayed. If region limitation 904 is set to be “factory limitation”, “factory limitation” is displayed. Inventory information database 125 of enterprise resource planning system 120 is searched for ones whose exit time 1503 is fixed within the scope of products, and the number of the ones is displayed in parentheses as the number of subjects.

The estimated cost 705 displays a cost calculated by the evaluation index calculation section 102 for the products of the scope (number of subjects) 704. If instruction type 703 is “recall”, the estimated number of days 706 displays the number of days calculated by the evaluation index calculation section 102 for the products of the scope (number of subjects) 704, and if instruction type 703 is “warning” or “suspension of sale”, the decision maker enters the required number of days into an input frame 707. The decision maker selects a countermeasure considered most appropriate from the selection of a countermeasure 702 by marking its checkbox 709 with a check and presses the countermeasure execution button 710.

In response to the press of the countermeasure execution button 710, the decision making GUI generation section 106 accepts the countermeasure check-marked by the decision maker operating the terminal 110 and the value inputted in the input frame 707.

Subsequently, in process S3024, the countermeasure and cause investigation request execution section 103 instructs to implement the countermeasure. In process S3030, the evaluation index calculation section 102 calculates the cost and number of days required for cause investigation for each party to be requested for cause investigation using traceability database 222, enterprise resource planning system 120, and cause investigation basic value database 52.

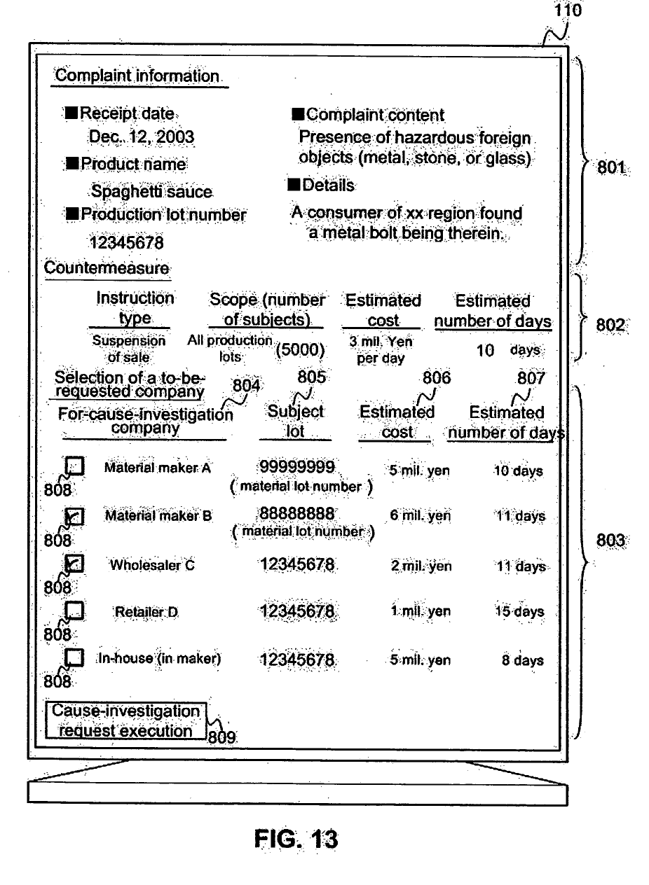

Subsequently, in process S3040, the decision making GUI generation section 106 puts together the cost and number of days calculated in process S3030 for each party to be requested for cause investigation and displays on the terminal 110. An example of the to-be-requested-for-cause-investigation company display screen is shown in FIG. 13. The screen of FIG. 13 has a complaint information 801 and a countermeasure 802, and a selection of a to-be-requested-for-cause-investigation company 803. The complaint information 801 displays complaint information entered by the complaint analyzer (the same in content as complaint information 701).

The countermeasure 802 displays the countermeasure of checkbox 709 check-marked in the screen of FIG. 12 by the decision maker through terminal 110, and countermeasure instruction type 703, scope (number of subjects) 704, estimated cost 705, and estimated number of days 706. The selection of a to-be-requested-for-cause-investigation company 803 shows candidates for being requested for cause-investigation and comprises a for-cause-investigation company 804, a subject lot 805, an estimated cost 806, an estimated number of days 807, a checkbox 808, and a cause-investigation request execution button 809.

Having searched traceability database 222 for companies involved in the product of complaint information 801 using product ID 1006 and production lot number 1007, the for-cause-investigation company 804 displays the companies of having-the-product-company ID 1002, and having extracted raw material of the product of complaint information 801 from bill-of-materials database 124 of enterprise resource planning system 120 and searched traceability database 222 for companies involved in the raw material using product ID 1006 and production lot number 1007, displays the companies of having-the-product-company ID 1002.

The subject lot 805 displays the production lot number of complaint information 801, and as to raw material, having extracted the production lot number 1408 of the raw material 1402 from bill-of-materials database 124 of enterprise resource planning system 120, displays as a raw material lot number. The estimated cost 806 shows an estimated cost for cause-investigation and the estimated number of days 807 shows an estimated number of days for the cause-investigation. Having searched cause investigation basic value database 52 for a cause-investigation basic cost 1204 using for-cause-investigation company ID 1201, product ID 1202, and complaint content 1203, the estimated cost 806 displays the searching result. Having searched for a cause-investigation basic time 1205, the estimated number of days 807 displays the searching result. The decision maker selects a candidate for being requested from the to-be-requested-for-cause-investigation company 803, check-marks checkbox 808 of the company to be requested, and presses the cause-investigation request execution button 809. A plurality of checkboxes 808 may be check-marked.

In response to the press of the cause-investigation request execution button 809, the decision making GUI generation section 106 accepts the company to be requested for cause-investigation whose checkbox 808 has been check-marked by the decision maker operating the terminal 110.

Subsequently, in process S3060, the countermeasure and cause investigation request execution section 103 requests to investigate the cause, thus finishes the process flow.

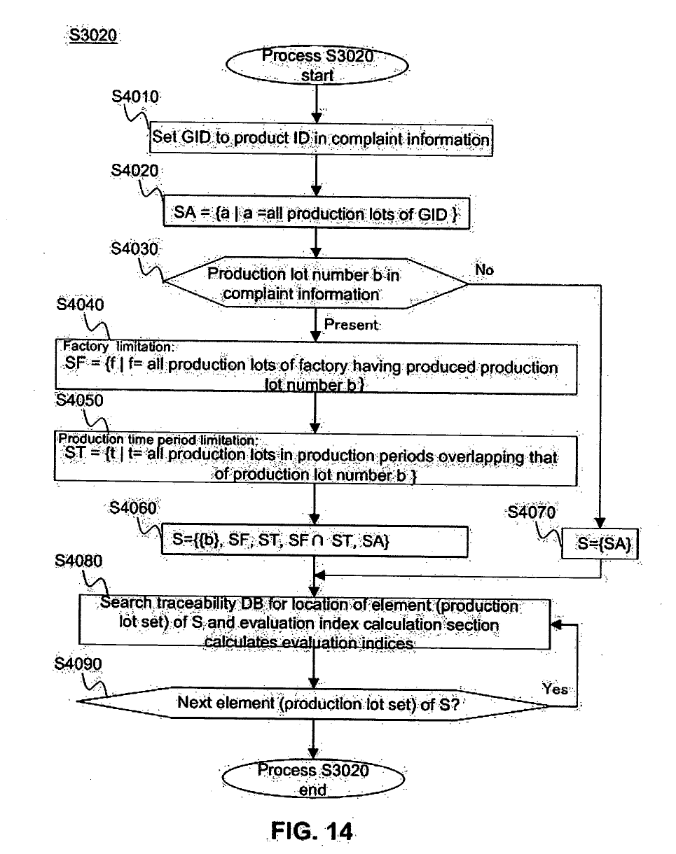

Next, each of processes S3020, S4080, S3030 of the above process flow will be described with reference to a detailed process flow. First, FIG. 14 shows a process flow of process S3020 by the evaluation index calculation section 102. In process S4010 of this process flow, a variable “GID” is set to the product ID included in complaint information received from terminal 20 of the complaint analyzer. Then in process S4020, having searched inventory information database 125 of enterprise resource planning system 120 for a product ID 1505 that matches the variable “GID” and searched for production lot numbers 1506 having exit time 1503 fixed out of them, a set of the production lot numbers is marked as “SA”.

Next, in process S4030, it is determined whether a production lot number is included in complaint information received from terminal 20 of the complaint analyzer. If a production lot number is present (S4030: present), it is placed into a variable “b” and proceeds to process S4040. On the other hand, if not present (S4030: non-present), the process proceeds to process S4070.

The above process S4040 searches manufacture history database 123 of enterprise resource planning system 120 for a factory ID 1306 whose production lot number 1305 matches the variable “b”, and searches for production lot numbers 1305 having the same factory ID as that. A set of the production lot numbers is marked as “SF”.

Process S4050 searches manufacture history database 123 of enterprise resource planning system 120 for a work start time 1307 and work end time 1308 whose production lot number 1305 matches the variable “b”, and searches for production lot numbers 1305 having a work start time and work end time close thereto, those time periods overlapping. A set of the production lot numbers is marked as “ST”.

Process S4060 marks a set of patterns of production lot numbers that are subject to the countermeasure as “S”. Elements of the set “S” are the production lot number “b”, set “SF”, set “ST”, a product set of “SF” and “ST”, and set “SA”, and hence, include all possible patterns for countermeasure.

On the other hand, process S4070 marks a set of patterns of production lot numbers that are subject to the countermeasure as “S”, and the only element of the set “S” is the set “SA”. This is because no production lot number is included in the complaint information, the production lot number “b”, set “SF”, and set “ST” are not known.

Subsequently, process S4080 searches traceability database 222 for the locations of products of an element of the set “S”, and the evaluation index calculation section 102 calculates a cost and number of days as evaluation indices.

In process S4090, it is determined whether set “S” has the next element. If the next element is present, the process returns to process S4080. If not, there are obtained the calculated evaluation indices (cost and number of days) for each element of set “S” as evaluation indices for a countermeasure, the process flow of S3020 finishes.

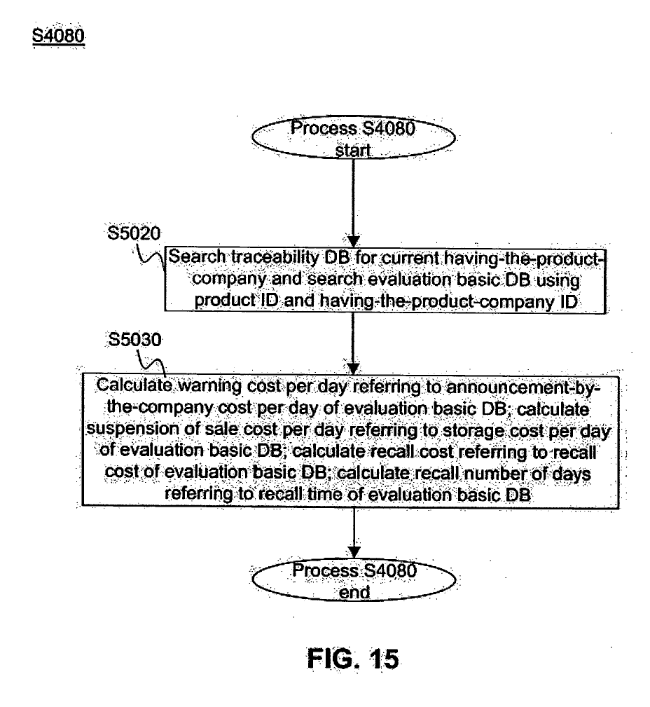

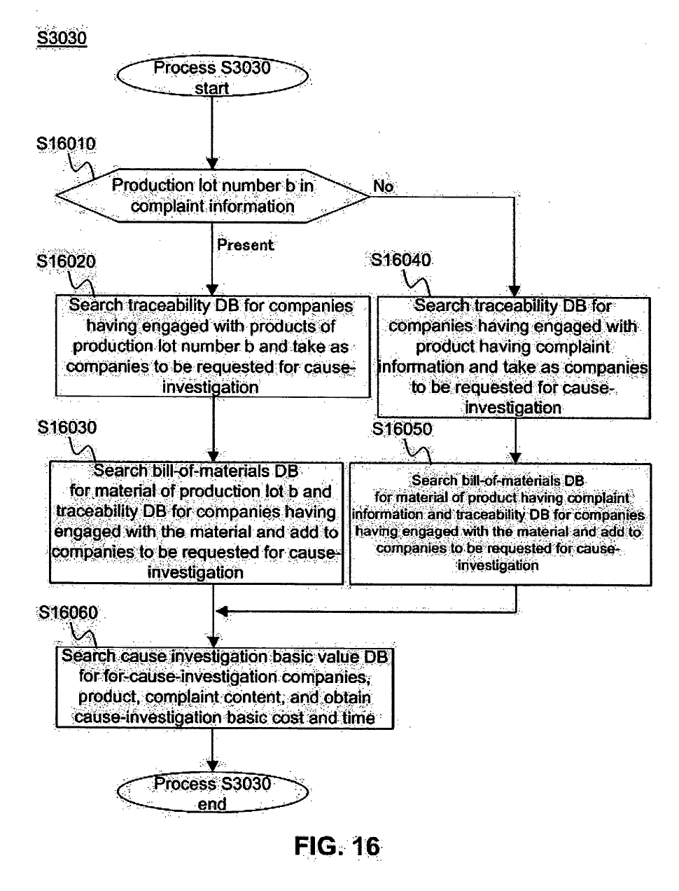

Next, the detailed process flow of S4080 by the evaluation index calculation section 102 will be described. FIG. 15 shows the flow. Process S5020 searches to see in which company the products of an element of the set “S” are. In this search, having searched traceability database 222 for production lot numbers 1007 matching each of the production lots that form the element of the set “S”, the company of having-the-product-company ID 1002 whose date and time 1004 is latest of the production lot numbers 1007 is taken as a current company having the products. Having searched the evaluation basic database 51 for the having-the-product-company ID 1102 and product ID 1101 matching the found having-the-product-company ID 1002 and product ID 1006 of the products, the process S5020 extracts the matching ones' recall cost 1103, recall time 1104, storage cost per day 1105 and announcement-by-the-company cost per day 1106. This process is repeated for all the production lots that form the element of the set “S”.

In subsequent process S5030, the evaluation indices, the costs and number of days, are calculated. Let “i” be one product within the subject scope; “j” be a company having the product; a(i, j) be a cost per day for keeping i in j; c(i, j) be a cost for recalling i from j; d(i, j) be time for recalling i from j; and y(i, j) be the number of i's in j.

A warning cost per day is obtained by substituting announcement-by-the-company cost per day 1106 into the following equation:

Warning cost per day=announcement-by-the-company cost per day.

A suspension of sale cost per day is obtained by adding the product of the number of products in the company of a having-the-product-company ID 1102 and storage cost per day 1105 for companies having the product as follows:

$$Suspension of sale cost per day = {\sum }_{i} {\sum }_{j} a ( i , j ) \times y ( i , j )$$

A recall cost is obtained by adding the product of the number of products in the company of a having-the-product-company ID 1102 and recall cost 1103 for companies having the product as follows:

$$Recall cost = {\sum }_{i} {\sum }_{j} c ( i , j ) \times y ( i , j )$$

The number of days for recall is obtained by substituting the maximum value of recall times 1104 into the following equation:

$$Number of days for recall = {Max}_{i} {Max}_{j} d ( i , j )$$

When all these calculations finishes, process S4080 is complete.

Next, the detailed process flow of S3030 by the evaluation index calculation section 102 will be described. FIG. 16 shows the flow. In process S16010, it is determined whether a production lot number is included in complaint information received from terminal 20 of the complaint analyzer. If a production lot number is present, it is placed into the variable “b” and proceeds to process S16020. If not present, the process proceeds to process S16040.

Process S16020 searches traceability database 222 for companies that have engaged with products of the production lot number “b” through arrival and shipment thereof. In this search, having-the-product-company IDs 1002 whose production lot number 1007 in traceability database 222 is “b” are extracted. The companies of the extracted having-the-product-company IDs 1002 are taken as companies to be requested for cause-investigation.

Process S16030 searches bill-of-materials database 124 of enterprise resource planning system 120 for raw material 1402 and production lot number 1408 of products of the production lot number “b” and then searches traceability database 222 for companies that have engaged with the raw material of the production lot number 1408 through arrival and shipment thereof. In this search, having-the-product-company IDs 1002 whose production lot number 1007 in traceability database 222 matches the production lot number 1408 are extracted. The companies of the extracted having-the-product-company IDs 1002 are added to the companies to be requested for cause-investigation. Then the process proceeds to process S16060.

On the other hand, process S16040 searches traceability database 222 for companies that have engaged with the product having the complaint information through arrival and shipment thereof. In this search, having-the-product-company IDs 1002 whose product ID 1006 in traceability database 222 matches the product ID of the product having the complaint information are extracted. The companies of the extracted having-the-product-company IDs 1002 are taken as the companies to be requested for cause-investigation.

Process S16050 searches bill-of-materials database 124 of enterprise resource planning system 120 for raw material 1402 of the product and then searches traceability database 222 for companies that have engaged with the raw material of product ID 1407 of the raw material 1402 through arrival and shipment thereof. In this search, having-the-product-company IDs 1002 whose production ID 1006 in traceability database 222 matches the product ID 1407 of the raw material are extracted. The companies of the extracted having-the-product-company IDs 1002 are added to the companies to be requested for cause-investigation.

Process S16060 searches cause investigation basic value database 52 for for-cause-investigation company IDs 1201 that match the companies to be requested for cause-investigation determined in processes S16020 to S16050 and whose product ID 1202 and complaint content 1203 match the product ID and complaint content in the complaint information (if no complaint content is in the complaint information, whose complaint content 1203 is unknown), and extracts their cause-investigation basic costs 1204 and cause-investigation basic times 1205. The extracted cause-investigation basic costs 1204 and cause-investigation basic times 1205 are taken as the costs and numbers of days required for cause-investigation, and the process S3030 finishes.

In this embodiment, instead of process S3022 of FIG. 10, process SS below may be carried out to narrow the scope of countermeasures to be displayed on terminal 110 of the decision maker, thereby making it easy to make a decision.

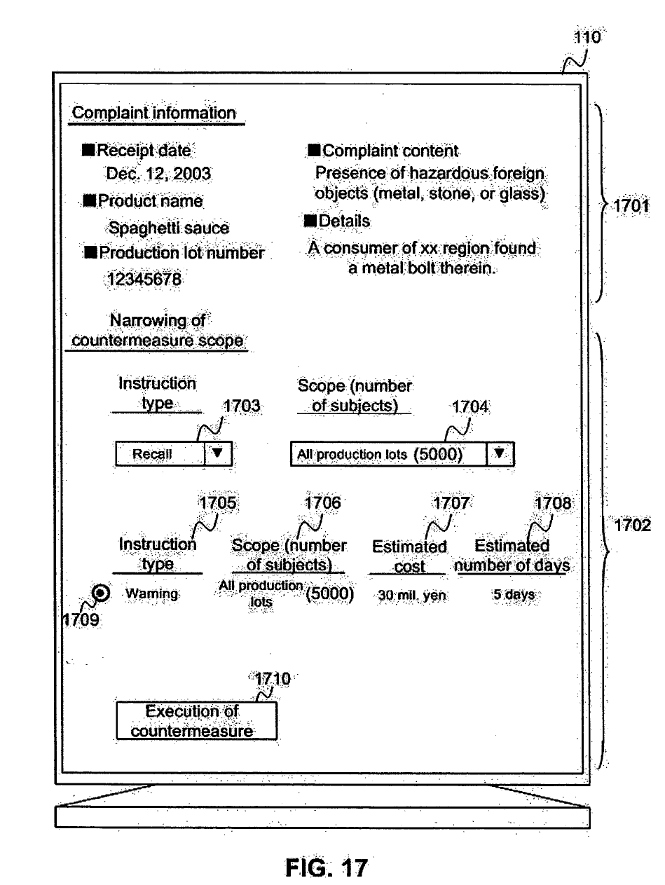

In process SS, the decision making GUI generation section 106 displays a countermeasure scope narrowing screen on terminal 110. FIG. 17 shows an example of the countermeasure scope narrowing screen. This countermeasure scope narrowing screen has complaint information 1701 and countermeasure scope narrowing 1702.

The complaint information 1701 displays the complaint information (the same in content as complaint information 701) entered by the complaint analyzer. The countermeasure scope narrowing 1702 comprises an instruction type pull-down menu 1703, a scope (number of subjects) pull-down menu 1704, an instruction type 1705, a scope (number of subjects) 1706, an estimated cost 1707, an estimated number of days 1708, a checkbox 1709, and a countermeasure execution button 1710. The instruction type pull-down menu 1703 is a list of instruction types 703, and the decision maker selects an instruction type from the list through terminal 110.

The decision making GUI generation section 106 displays the instruction type selected by the decision maker through terminal 110 in instruction type 1705. The scope (number of subjects) pull-down menu 1704 is a list of scopes (numbers of subjects) 704, and the decision maker selects a scope for instruction from the list through terminal 110.

The decision making GUI generation section 106 displays the scope for instruction selected by the decision maker through terminal 110 in scope (number of subjects) 1706, and displays the cost and number of days calculated in process S3020 for the countermeasure of instruction type 1705 and scope (number of subjects) 1706 in estimated cost 1707 and estimated number of days 1708. Next, in response to the press of the countermeasure execution button 1710, the decision making GUI generation section 106 accepts the countermeasure whose checkbox 1709 has been check-marked by the decision maker operating the terminal 110.

Note that in the above process flow, either of processes S3020 to S3024 and processes S3030 to S3060 may be prior to the other, or only one of them may be executed.

Embodiment 2

Embodiment 2 of the present invention will be described. Embodiment 2 has a lot of common parts with Embodiment 1, and hence, with the common parts being omitted, a description will be made centered on the differences.

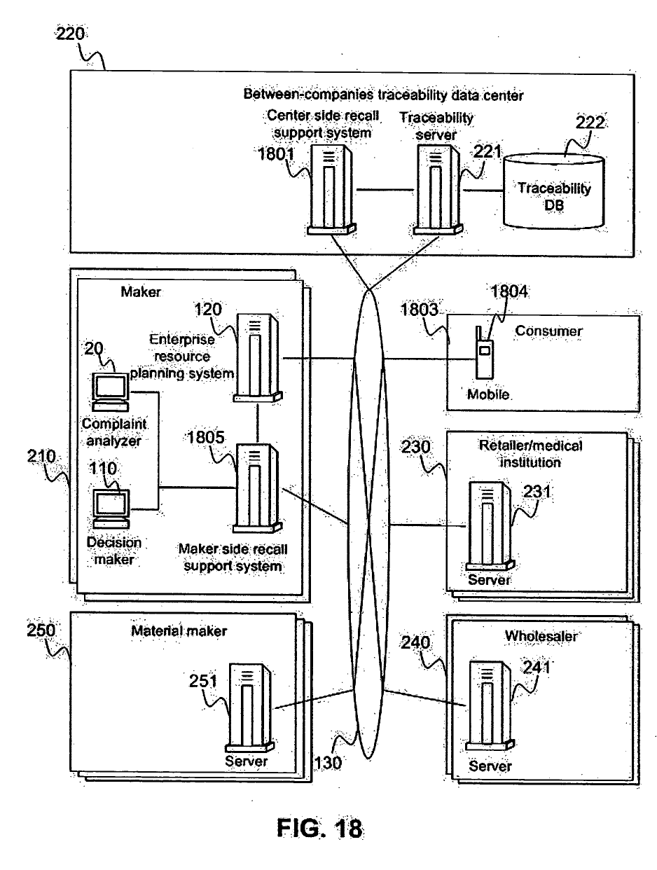

FIG. 18 is a view of the configuration of a whole between-companies traceability system including a center side recall support system 1801 and a maker side recall support system 1805 in use. In Embodiment 2, the functions of recall support system 100 described in Embodiment 1 are realized cooperatively by both center side recall support system 1801 and maker side recall support system 1805.

The complaint analyzer of maker 210 enters complaint information sent from a mobile terminal 1804 of a consumer 1803 or the like into maker side recall support system 1805 through terminal 20. Maker side recall support system 1805 identifies conceivable recall countermeasures, and acquires and uses data necessary for dealing with a recall (the cost and number of days required for implementing each countermeasure, candidates for being requested for cause investigation, etc.) from center side recall support system 1801 of between-companies traceability data center 220. Then, maker side recall support system 1805 presents the conceivable countermeasures, the candidates for being requested for cause investigation, and the like to terminal 110 of the decision maker, and once a decision is made, instructs center side recall support system 1801 to execute the decided.

Meanwhile, center side recall support system 1801 of between-companies traceability data center 220 calculates the cost and number of days required for implementing each countermeasure, and sends the calculation results to maker side recall support system 1805.

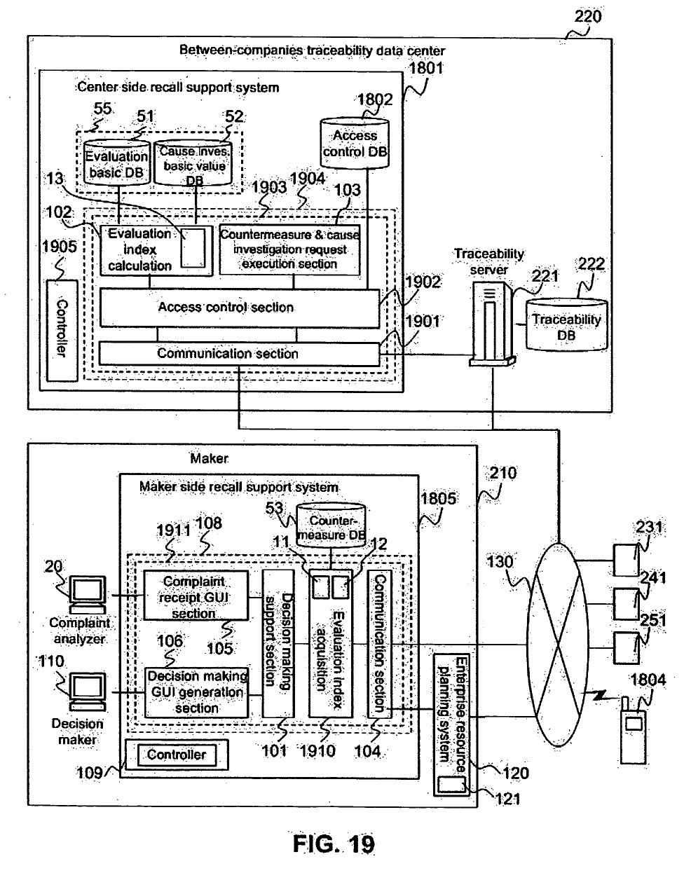

FIG. 19 illustrates in more detail maker side recall support system 1805 of maker 210 and center side recall support system 1801 of between-companies traceability data center 220.

In FIG. 19, maker side recall support system 1805 comprises a decision making support section 101, an evaluation index acquiring section 1910, a communication section 104, the complaint receipt GUI section 105, and the decision making GUI generation section 106. Note that these function sections of the recall support system of the invention may be realized by a program 1911, which is stored in the storage apparatus (e.g. memory) 108 of the system and read out and executed by the controller 109 including a computing apparatus, i.e., a CPU.

Here, decision making support section 101 controls the process flow of the whole recall support system. Evaluation index acquiring section 1910 acquires evaluation indices necessary for decision making by the decision maker such as the cost and number of days required for implementing each countermeasure from center side recall support system 1801, referring to the countermeasure database 53 and the like.

Moreover, evaluation index acquiring section 1910 comprises the product attribute acquiring section 11 that acquires complaint information due to the occurrence of a problem in a product from the complaint receipt GUI section 105 (input interface) and extracts a product attribute from the complaint information. Evaluation index acquiring section 1910 further comprises a countermeasure information acquiring section 12 that acquires information about the cost and time period required for implementing each countermeasure or cause investigation which information is corresponding to the extracted product attribute.

As described above, the evaluation index acquiring section 1910 extracts execution scope information for each type of countermeasure or cause investigation included in countermeasure database 53, and calculates the evaluation indices for each type of countermeasure or cause investigation by applying the information (acquired from center side recall support system 1801) about the cost and time period required for implementing the countermeasure or the cause investigation to the execution scope information.

Moreover, the evaluation index acquiring section 1910 extracts candidates for being requested to implement a countermeasure or cause investigation from one of center side recall support system 1801 and countermeasure database 53, and sends information about the candidates to the decision making GUI generation section 106 (output processing section) to have it output to an output interface.

In FIG. 19, center side recall support system 1801 comprises an evaluation index calculation section 102, a countermeasure and cause investigation request execution section 103, an access controller 1902, and a communication section 1901. Note that these function sections of the center side recall support system of the invention may be realized by a program 1903, which is stored in a storage apparatus (e.g. memory) 1904 of the system and read out and executed by a controller 1905 including a computing apparatus, i.e., a CPU.

Here, the evaluation index calculation section 102 comprises a location information acquiring section 13 that acquires information about whereabouts of the products from traceability database 222 which information is corresponding to the product attribute referred thereto by maker side recall support system 1805.

As described above, the evaluation index calculation section 102 calculates the evaluation indices for each type of countermeasure or cause investigation by applying the information (acquired from basic database 55) about the cost and time period required for implementing the countermeasure or the cause investigation to the execution scope information extracted by maker side recall support system 1805.

Moreover, the evaluation index calculation section 102 extracts candidates for being requested to implement a countermeasure or cause investigation from one of basic database 55 and traceability database 222, or from a database storing a list of parties to implement a countermeasure or cause investigation, and sends information about the candidates to maker side recall support system 1805 via communication section 1901. At this time, evaluation index calculation section 102 determines whether it is all right to disclose the specific names and the like of candidates for being requested to implement a countermeasure or cause investigation to maker side recall support system 1805, referring to access control database 1802 via access controller 1902, thus sending a scope of information that can be disclosed.

The countermeasure and cause investigation request execution section (instruction execution section) 103 receives the selection of a countermeasure or cause investigation from maker side recall support system 1805. The selection of a countermeasure or cause investigation is one that the maker side recall support system 1805 has accepted through an input interface (a GUI displayed on the terminal 110 being used by the decision maker) in response to the evaluation index information output to an output interface (a GUI displayed on the terminal 110 being used by the decision maker) via decision making GUI generation section 106.

The execution section 103 outputs an instruction to implement the countermeasure or cause investigation to an output interface. The output is output to the server 231 of the retailer/medical institution, the server 241 of the wholesaler, the server 251 of the material maker, or mobile terminal 1804 of consumer 1803, for example.

The communication section 1901 communicates with traceability server 221 and via communication line 130 with enterprise resource planning system 120, the servers 231, 241, 251 of the other companies, and mobile terminal 1804 of the consumer. Communication section 121 of enterprise resource planning system 120 communicates with maker side recall support system 1805 and via communication line 130 with the other companies.

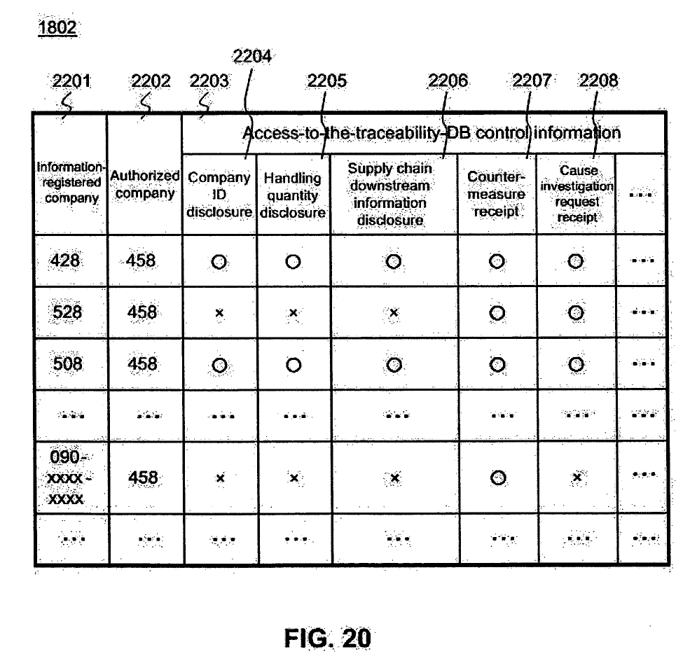

Next, of the above databases, access control database 1802 provided in center side recall support system 1801 will be described in detail that is not described in Embodiment 1. FIG. 20 shows an example of access control database 1802.

Access control database 1802 is a database storing information about whether specific names of the candidates for being requested to implement a countermeasure or cause investigation and the like are allowed to be disclosed. Its data structure comprises, for example, an information-registered company 2201, an authorized company 2202, and an access-to-the-traceability-database control information 2203.

The information-registered company 2201 indicates a company having registered the information in traceability database 222. When consumer 1803 has registered the information, mobile terminal 1804 of the consumer may be indicated. The authorized company 2202 indicates a company to use the information (registered information in the traceability database). The access-to-the-traceability-database control information 2203 specifies to what extent use of information is allowed as to the information (registered information in the traceability database), and comprises information about whether disclosure is allowed or to what extent it is allowed, for a company ID disclosure 2204, a handling quantity disclosure 2205, a supply chain downstream information disclosure 2206, receipt of a countermeasure 2207, receipt of request for cause investigation 2208, and the like.

Here, information of company ID disclosure 2204 indicates whether information of for-cause-investigation company ID 1201 (see FIG. 5) out of information which the information-registered company 2201 has registered in traceability database 222 is allowed to be disclosed to (or used by) authorized company 2202. Information of handling quantity disclosure 2205 indicates whether the quantity of products (calculated from traceability database 222) being handled by information-registered company 2201 is allowed to be disclosed to authorized company 2202. Information of supply chain downstream information disclosure 2206 indicates whether information in traceability database 222 registered by companies downstream of information-registered company 2201 in supply chain is allowed to be disclosed to authorized company 2202. Information of receipt of a countermeasure 2207 indicates whether, when a problem has occurred in a product, information-registered company 2201 accepts the instruction of the countermeasure that authorized company 2202 has decided on. Information of receipt of request for cause investigation 2208 indicates whether, when a problem has occurred in a product, information-registered company 2201 accepts request for cause investigation from authorized company 2202.

Note that sections 101, 104 to 106, and 1910 of maker side recall support system 1805 may be embodied as hardware or as a program stored in an appropriate storage apparatus such as an HDD or memory, which program the controller 109 of maker side recall support system 1805 reads out from the storage apparatus into memory 108 as needed and executes it.

Furthermore, sections 1901, 1902, 102, and 103 of center side recall support system 1801 may be embodied as hardware or as a program stored in an appropriate storage apparatus such as an HDD or memory, which program the controller 1905 of center side recall support system 1801 reads out from the storage apparatus into memory 1904 as needed and executes it.

As opposed to the embodiment where maker side recall support system 1805 is connected to the external apparatuses of terminal 20 of the complaint analyzer, terminal 110 of the decision maker, enterprise resource planning system 120, center side recall support system 1801, and between-companies traceability data center 220 via communication line 130, and where center side recall support system 1801 is connected to the external apparatuses of traceability server 221 and the like, and where they send/receive data with each other, an embodiment where all or some of the above external apparatuses are included in maker side recall support system 1805 and center side recall support system 1801 as their components is conceivable. Furthermore, in the case of maker side recall support system 1805 and center side recall support system 1801 comprising the external apparatuses, the external apparatuses may cooperate with the systems over communication line 130 or be integrated in hardware with the systems.

Next, the execution procedure of a recall support method according to the present embodiment will be described. This execution procedure has a lot of common parts with the execution procedure of FIGS. 10, 14 to 16 described in Embodiment 1, and hence, with the common parts being omitted, a description will be made centered on the differences. Although in Embodiment 1, the process flow is controlled by the decision making support section 101 of recall support system 100, in this embodiment, the process flow is controlled by function sections of maker side recall support system 1805 or center side recall support system 1801.

Processes S3024 and S3060 of FIG. 10 in Embodiment 1 change for Embodiment 2 as follows.

In process S3024, decision making support section 101 of maker side recall support system 1805 sends the instruction of the countermeasure accepted in process S3022 to center side recall support system 1801. In center side recall support system 1801, the countermeasure and cause investigation request execution section 103 instructs to implement the countermeasure.

In process S3060, decision making support section 101 of maker side recall support system 1805 sends the request for cause investigation accepted in process S3040 to center side recall support system 1801. In center side recall support system 1801, the countermeasure and cause investigation request execution section 103 requests for cause investigation.

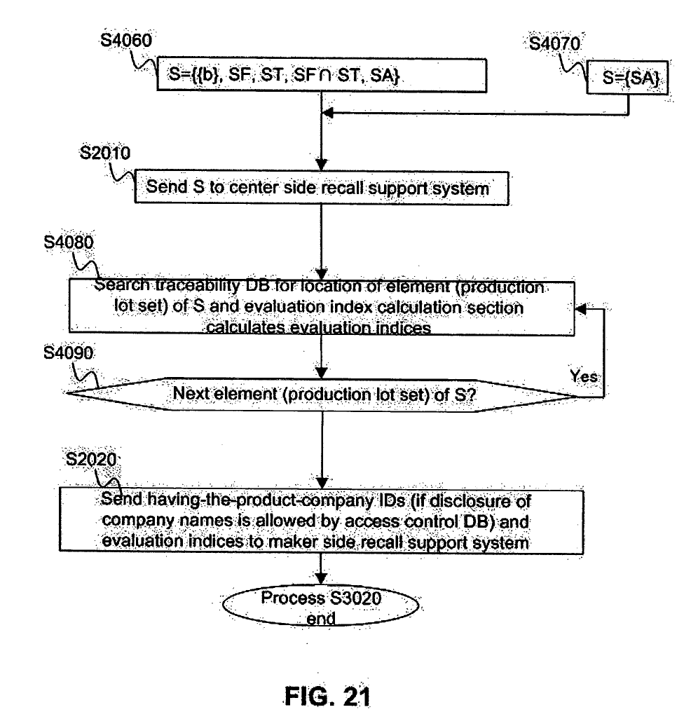

FIG. 21 shows processes of from S4060, S4070 to the end of S3020, which are changed for Embodiment 2, out of the process flow of FIG. 14 in Embodiment 1. Here, access controller 1902 of center side recall support system 1801 of between-companies traceability data center 220 controls processes S4080, S4090, and S2020.

In process S2010, maker side recall support system 1805 (or enterprise resource planning system 120) sends the set “S” of patterns of production lot numbers that are subject to the countermeasure to center side recall support system 1801.

In process S4080, as in Embodiment 1, center side recall support system 1801 searches traceability database 222 for the locations of products of an element of the set “S”, and the evaluation index calculation section 102 calculates a cost and number of days as evaluation indices.

In process S4090, as in Embodiment 1, center side recall support system 1801 determines whether set “S” has the next element. If the next element is present, the process returns to process S4080. If not, the process proceeds to process S2020.

In process S2020, center side recall support system 1801 sends the evaluation indices (cost and number of days) for each element of set “S”, taken as evaluation indices for each countermeasure, together with company names and handling quantities allowed to be disclosed by access control database 1802 to maker side recall support system 1805, and the process S3020 finishes.

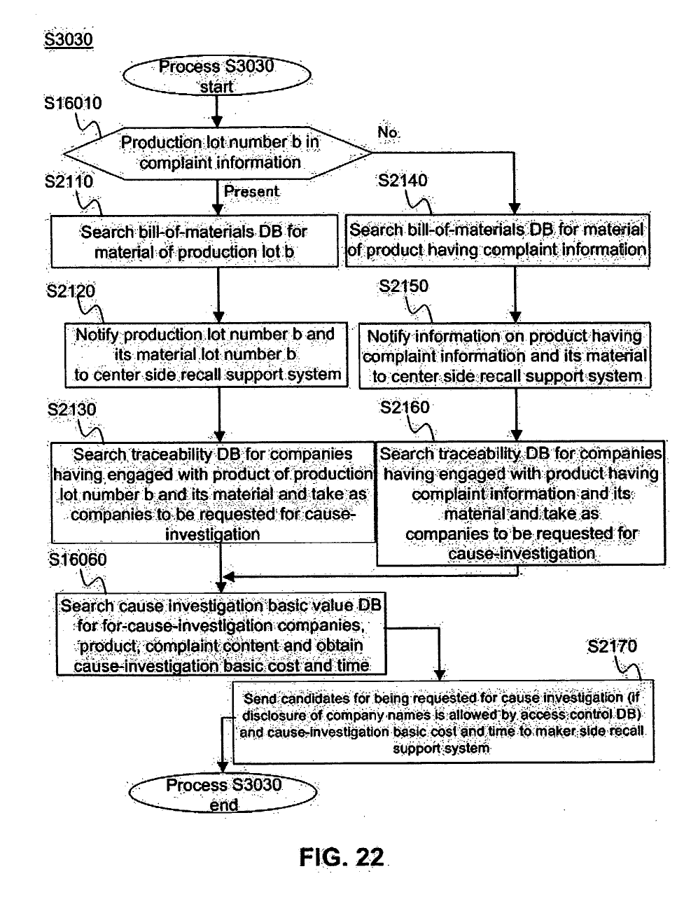

FIG. 22 shows processes changed for Embodiment 2 out of the process flow of FIG. 16 in Embodiment 1. Here, access controller 1902 of center side recall support system 1801 of between-companies traceability data center 220 controls processes S2130, S2160, S16060, and S2170.

In process S16010, as in Embodiment 1, maker side recall support system 1805 determines whether a production lot number is included in complaint information received from terminal 20 of the complaint analyzer. If a production lot number is present, it is placed into a variable “b” and proceeds to process S2110. If not present, the process proceeds to process S2140.

In process S2110, the maker side recall support system 1805 searches bill-of-materials database 124 of enterprise resource planning system 120 for raw material 1402 of the product having the production lot number “b” and its production lot number 1408.

In process S2120, the maker side recall support system 1805 sends the production lot number “b” and production lot number 1408 of raw material 1402 to center side recall support system 1801.

In process S2130, center side recall support system 1801 searches traceability database 222 for companies that have engaged with products of production lot number “b” through arrival and shipment thereof. In this search, having-the-product-company IDs 1002 whose production lot number 1007 in traceability database 222 matches production lot number “b” are extracted. The companies of the extracted having-the-product-company IDs 1002 are taken as companies to be requested for cause-investigation.

Furthermore, as to the product's raw material 1402 and its production lot number 1408, center side recall support system 1801 searches traceability database 222 via traceability server 221 for companies that have engaged with products of production lot number 1408 through arrival and shipment thereof. In this search, having-the-product-company IDs 1002 whose production lot number 1007 in traceability database 222 matches production lot number 1408 are extracted.

Center side recall support system 1801 adds the companies of the extracted having-the-product-company IDs 1002 to the companies to be requested for cause-investigation. Then the process proceeds to process S16060.

On the other hand, in process S2140, the maker side recall support system 1805 searches bill-of-materials database 124 of enterprise resource planning system 120 for raw material 1402.

In process S2150, the maker side recall support system 1805 sends information about the product having the complaint information and the product's raw material 1402 to center side recall support system 1801.

In process S2160, center side recall support system 1801 searches traceability database 222 via traceability server 221 for companies that have engaged with the product of the complaint information through arrival and shipment thereof. In this search, having-the-product-company IDs 1002 whose product ID 1006 in traceability database 222 matches the product of the complaint information are extracted. The companies of the extracted having-the-product-company IDs 1002 are taken as companies to be requested for cause-investigation. Moreover, center side recall support system 1801 searches traceability database 222 for companies that have engaged with products of product ID 1407 of raw material 1402 through arrival and shipment thereof. In this search, having-the-product-company IDs 1002 whose product ID 1006 in traceability database 222 matches product ID 1407 of the raw material are extracted. Center side recall support system 1801 adds the companies of the extracted having-the-product-company IDs 1002 to the companies to be requested for cause-investigation.

In process S16060, as in Embodiment 1, center side recall support system 1801 searches cause investigation basic value database 52 for for-cause-investigation company IDs 1201 that match the companies to be requested determined in processes S2110 to S2160 and whose product ID 1202 and complaint content 1203 match the product ID and complaint content in the complaint information (if no complaint content is in the complaint information, whose complaint content 1203 is unknown), and extracts their cause-investigation basic costs 1204 and cause-investigation basic times 1205. The extracted cause-investigation basic costs 1204 and cause-investigation basic times 1205 are taken as the costs and numbers of days required for cause-investigation.

In process S2170, center side recall support system 1801 sends the costs and numbers of days required for cause-investigation together with company names allowed to be disclosed by access control database 1802 to maker side recall support system 1805, and the process S3030 finishes.

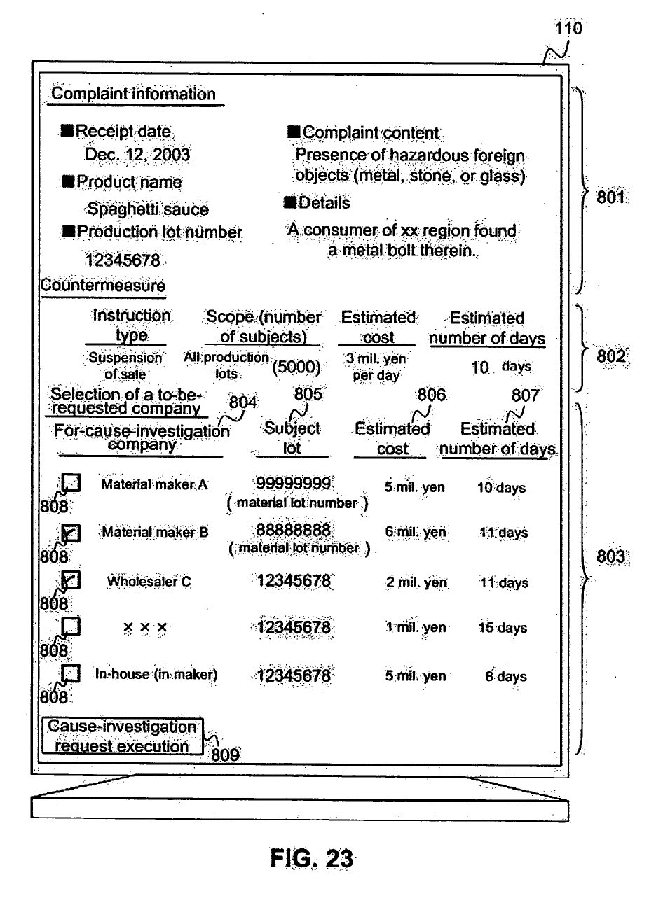

While in process S3040 of FIG. 10 in Embodiment 1, the to-be-requested-for-cause-investigation company display screen is shown in, for example, FIG. 13, in Embodiment 2, the to-be-requested-for-cause-investigation company display screen is shown in, for example, FIG. 23. FIG. 23 differs from FIG. 13 in that for some of for-cause-investigation companies 804, instead of their company ID (or company name), “XXX” is displayed which indicates that company ID disclosure 2204 of access control database 1802 does not allow the disclosure of the company name in S2170.

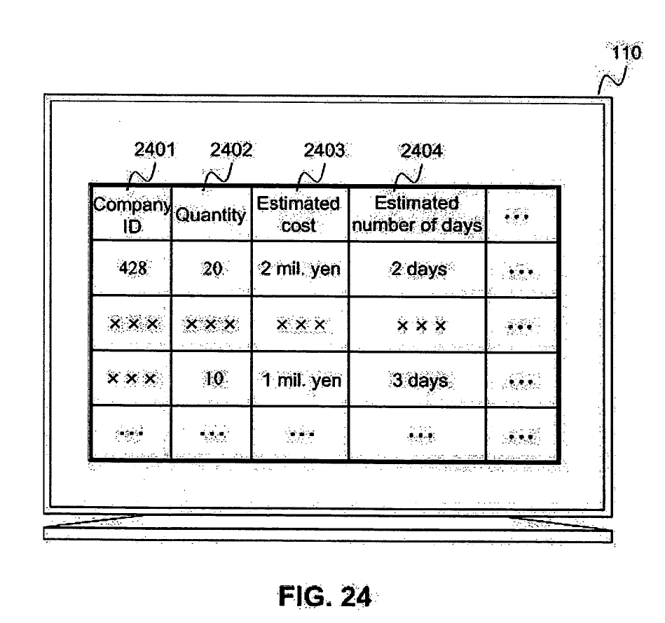

In processes S3022 and SS of Embodiment 1, a decision on countermeasure is input via the countermeasure display screen of FIG. 12 and the countermeasure scope narrowing screen of FIG. 17 displayed on terminal 110. In this case, since referring to traceability database 222, it is possible for recall support system 100 to accept the decision after having the decision maker confirm the whereabouts of the products by a specific company ID or name. In Embodiment 2, however, the disclosure of information of traceability database 222 may not be allowed in process S2020 depending on the setting of access control database 1802 and thus it may not be possible to have the decision maker confirm the specific company ID or name. Accordingly, a whereabouts confirmation screen for having the decision maker confirm the whereabouts of the products is, for example, the screen shown in FIG. 24. The whereabouts confirmation screen of FIG. 24 has a company ID 2401, a quantity 2402, an estimated cost 2403, an estimated number of days 2404. The company ID 2401 displays a company ID as the whereabouts of products. The quantity 2402 displays the quantity of products that are subject to a countermeasure and possessed by the company ID 2401. The estimated cost 2403 displays the cost required for the quantity 2402 out of the estimated cost for the countermeasure. The estimated number of days 2404 displays the number of days required for the quantity 2402 out of the estimated number of days for the countermeasure.

According to the present invention, it is possible to present a plurality of conceivable recall countermeasures to the decision maker or the like and also to present an estimated cost and number of days required for implementing each countermeasure thereby supporting the decision maker in deciding on a countermeasure. By this means, a maker can quickly make a decision on recall countermeasure in view of the estimated costs and numbers of days. Furthermore, when analyzing the cause of a complaint about a product, it is possible to instruct particular companies that have engaged with the product to investigate the cause. As a result, it becomes clear which company is responsible for the complaint thereby reducing the new occurrences of complaint.

Therefore, a plurality of conceivable recall countermeasures different in conditions and the cost and number of days required for implementing each countermeasure can be proposed.

Having described a preferred embodiment of the invention with reference to the accompanying drawings, it is to be understood that the invention is not limited to the embodiments and that various changes and modifications could be effected therein by one skilled in the art without departing from the spirit or scope of the invention as defined in the appended claims.

1. A recall support system to present countermeasures or cause investigation for when problems occur in products, the system comprising:
a section that enables using a basic database storing information about costs or time periods required for the countermeasures or cause investigation, the costs or time periods being corresponding to attributes of products, and a countermeasure database storing information about an execution scope of each type of countermeasure or cause investigation of the countermeasures or cause investigation;
a product attribute acquiring section that acquires complaint information associated with the occurrence of a problem in a product from an input interface and extracts the attribute of the product included in the complaint information;
a countermeasure information acquiring section that acquires information about a cost or time period required for a countermeasure or cause investigation by referring the attribute of the product to the basic database, the cost or time period being corresponding to the attribute of the product of concern;
an evaluation index calculation section that extracts the information about the execution scope of each type of countermeasure or cause investigation included in the countermeasure database, and by applying the acquired information about the cost or time period required for the countermeasure or cause investigation to the execution scope, calculates evaluation indices including a cost or time period for each type of countermeasure or cause investigation; and
an output processing section that outputs information about the evaluation indices to an output interface.

2. The recall support system according to claim 1, further comprising:
a section that enables using a traceability database storing location information of products; and
a location information acquiring section that acquires location information of the product of concern by referring the attribute of the product to the traceability database,
wherein the evaluation index calculation section, with applying the acquired information about the cost or time period required for the countermeasure or cause investigation to the execution scope, for each type of countermeasure or cause investigation, calculates the number of days required for implementing the countermeasure or cause investigation based on the location information and a cost for the calculated number of days.

3. The recall support system according to claim 1, wherein the evaluation index calculation section extracts candidates for being requested to implement the countermeasure or cause investigation from one of the basic database, the countermeasure database, and the traceability database, or from a database storing a list of parties to implement a countermeasure or cause investigation, and sends information about the extracted candidates to the output processing section.

4. The recall support system according to claim 1, further comprising:
an instruction execution section that accepts the selection of a countermeasure or cause investigation through an output interface in response to the information about the evaluation indices output to the output interface, and output an instruction to implement the countermeasure or cause investigation to the output interface.

5. The recall support system according to claim 1, wherein the evaluation index calculation section receives the information about the execution scopes from another system being accessible via a network and having the information about the execution scopes, and by applying the acquired information about the cost or time period required for the countermeasure or cause investigation to the execution scope, calculates evaluation indices including a cost or time period for each type of countermeasure or cause investigation, and via a communication section, sends information about the evaluation indices to the other system.

6. The recall support system according to claim 1, comprising:
instead of the evaluation index calculation section, an evaluation index acquiring section that receives and acquires the evaluation indices calculated in another system provided with the evaluation index calculation section,
wherein the countermeasure information acquiring section acquires information about a cost or time period required for a countermeasure or cause investigation corresponding to the attribute of the product of concern by referring the attribute of the product extracted by the product attribute acquiring section from complaint information acquired through the input interface to the other system provided with the basic database and accessible via a network,
wherein the evaluation index acquiring section extracts the information about the execution scope of each type of countermeasure or cause investigation included in the countermeasure database and, via a communication section, sends to the other system, and
wherein the output processing section outputs information about the evaluation indices to the output interface.

7. The recall support system according to claim 1, further comprising:
an access controller that manages disclosure of the evaluation indices in the output interface by referring the evaluation indices to an access control database storing information about whether the evaluation index is allowed to be disclosed, for all or some of the evaluation indices, depending on information included in the evaluation indices.

8. A recall support method to present countermeasures or cause investigation for when problems occur in products by an information processing apparatus, the method comprising the steps of:
enabling use of a basic database storing information about costs or time periods required for the countermeasures or cause investigation, the costs or time periods being corresponding to attributes of products, and a countermeasure database storing information about an execution scope of each type of countermeasure or cause investigation of the countermeasures or cause investigation;
acquiring complaint information associated with the occurrence of a problem in a product from an input interface and extracting the attribute of the product included in the complaint information;
acquiring information about a cost or time period required for a countermeasure or cause investigation by referring the attribute of the product to the basic database, the cost or time period being corresponding to the attribute of the product of concern;
extracting the information about the execution scope of each type of countermeasure or cause investigation included in the countermeasure database, and by applying the acquired information about the cost or time period required for the countermeasure or cause investigation to the execution scope, calculating evaluation indices including a cost or time period for each type of countermeasure or cause investigation; and
outputting information about the evaluation indices to an output interface.

9. The recall support method according to claim 8, further comprising the steps of:
receiving the information about the execution scopes from another system being accessible via a network and having the information about the execution scopes;
applying the acquired information about the cost or time period required for the countermeasure or cause investigation to the execution scope to calculate evaluation indices including a cost or time period for each type of countermeasure or cause investigation; and
sending information about the evaluation indices to the other system.

10. The recall support method according to claim 8, further comprising the steps of:
acquiring information about a cost or time period required for a countermeasure or cause investigation corresponding to the attribute of the product of concern by referring the attribute of the product extracted by the product attribute acquiring section from complaint information acquired through the input interface to the other system provided with the basic database and accessible via a network;
extracting the information about the execution scope of each type of countermeasure or cause investigation included in the countermeasure database and sending to the other system;
receiving and acquiring the evaluation indices calculated in another system from the another system; and
outputting information about the evaluation indices to the output interface.

11. A computer software program for recall support to present countermeasures or cause investigation for when problems occur in products by an information processing apparatus which can use a basic database storing information about costs or time periods required for the countermeasures or cause investigation, the costs or time periods being corresponding to attributes of products, and a countermeasure database storing information about an execution scope of each type of countermeasure or cause investigation of the countermeasures or cause investigation, the computer software program having the information processing apparatus execute the following steps of:
acquiring complaint information associated with the occurrence of a problem in a product from an input interface and extracting the attribute of the product included in the complaint information;
acquiring information about a cost or time period required for a countermeasure or cause investigation by referring the attribute of the product to the basic database, the cost or time period being corresponding to the attribute of the product of concern;
extracting the information about the execution scope of each type of countermeasure or cause investigation included in the countermeasure database, and by applying the acquired information about the cost or time period required for the countermeasure or cause investigation to the execution scope, calculating evaluation indices including a cost or time period for each type of countermeasure or cause investigation; and
outputting information about the evaluation indices to an output interface.

12. The computer software program for recall support according to claim 11, having the information processing apparatus execute the further steps of:
receiving the information about the execution scopes from another system being accessible via a network and having the information about the execution scopes;
applying the acquired information about the cost or time period required for the countermeasure or cause investigation to the execution scope to calculate evaluation indices including a cost or time period for each type of countermeasure or cause investigation; and
sending information about the evaluation indices to the other system.

13. The computer software program for recall support according to claim 11, having the information processing apparatus execute the further steps of:
acquiring information about a cost or time period required for a countermeasure or cause investigation corresponding to the attribute of the product of concern by referring the attribute of the product extracted by the product attribute acquiring section from complaint information acquired through the input interface to the other system provided with the basic database and accessible via a network;
extracting the information about the execution scope of each type of countermeasure or cause investigation included in the countermeasure database and sending to the other system;
receiving and acquiring the evaluation indices calculated in another system from the another system; and
outputting information about the evaluation indices to the output interface.
